(19) United States
(12) Patent Application Publication
(10) Pub. No.: US 2020/0250401 A1
(43) Pub. Date: Aug. 6, 2020

(54) COMPUTER SYSTEM AND COMPUTER-READABLE STORAGE MEDIUM

(71) Applicant: ZENRIN CO., LTD., Kitakyushu-shi (JP)

(72) Inventors: Shogo KANEISHI, Fukuoka-shi (JP); Shigeyuki IWATA, Foster City, CA (US); Kenichiro MOTOYAMA, Kashiwa-shi (JP)

(73) Assignee: ZENRIN CO., LTD., Kitakyushu-shi (JP)

(21) Appl. No.: 16/710,924

(22) Filed: Dec. 11, 2019

Related U.S. Application Data
(60) Provisional application No. 62/801,479, filed on Feb. 5, 2019.

(51) Int. Cl. G06K 9/00; G06T 5/20; G06T 5/00

(52) U.S. Cl. CPC G06K 9/00221; G06T 2207/30201; G06T 5/002; G06T 5/20

(57) ABSTRACT

A computer system includes a processor configured to: recognize an attribute of a subject in a target area of an original image which is represented by original image data; convert the target area by applying a filter corresponding to the attribute to the target area such that personal information on the subject becomes unrecognizable and the attribute of the subject is recognizable; and output converted image data representing a converted image including the converted target area.

### CROSS-REFERENCE TO RELATED APPLICATIONS

This application claims the benefit of U.S. Patent Provisional Application No. 62/801,479, filed on Feb. 5, 2019, entitled “PRIVACY PRESERVATION APPARATUS”. All subject matter set forth in provisional application No. 62/801,479 is hereby incorporated by reference into the present application as if fully set forth herein.

### TECHNICAL FIELD

An aspect of the present disclosure relates to a computer system and a program.

### BACKGROUND

There are known technologies for blurring images in order to protect privacy (see Japanese Patent Application Laid-Open No. 2011-129096 (hereinafter, referred to as Patent Literature 1) and Japanese Patent Application Laid-Open No. 2016-126597 (hereinafter, referred to as Patent Literature 2), for instance).

### SUMMARY

An object of an aspect of the present disclosure is to appropriately process images.

A computer system according to an aspect of the present disclosure includes a processor. The processor is configured to recognize an attribute of a subject in a target area of an original image which is represented by original image data, and convert the target area by applying a filter corresponding to the attribute to the target area such that personal information on the subject becomes unrecognizable and the attribute of the subject is recognizable, and output converted image data representing a converted image including the converted target area.

### BRIEF DESCRIPTION OF DRAWINGS

FIG. 1 is a view illustrating an example of the hardware configuration of an image processing system according to an embodiment;

FIG. 2 is a view illustrating an example of the functional configuration of the image processing system according to the embodiment;

FIG. 3 is a flow chart illustrating an example of attribute filter generation;

FIG. 4 is a view illustrating an example of an attribute filter;

FIG. 5 is a flow chart illustrating an example of processing for acquiring a converted image from an original image; and

FIG. 6 is a flow chart illustrating a more concrete example of the processing illustrated in FIG. 5.

### DESCRIPTION OF EMBODIMENTS

Hereinafter, an embodiment in the present disclosure will be described in detail with reference to the accompanying drawings.

Also, in the descriptions of the drawings, the same or identical elements are denoted by the same reference symbols, and a repetitive description thereof will not be made.

[Outline of System]

An image processing system 10 according to an embodiment is a computer system for converting at least a part of an original image which is represented by original image data, and generating converted image data representing the converted image acquired by the converting process. The images mean images from which people can visually recognize some information. The original image means an image which is processed by the image processing system 10. The original image may be an image generated by an imaging device such as a camera, or may be an image subjected to arbitrary other image processing after imaging. The original image data means electronic data representing the original image. The converted image means an image which is obtained by converting at least a part of the original image. The converted image data means electronic data representing the converted image. Both of the original image data and the converted image data can be processed to be visualized by a computer, such that people can visually recognize the original image and the converted image. Both of the original image and the converted image may be still images, i.e. photographs, or may be frame images constituting a video.

The image processing system 10 acquires a converted image by converting an original image such that personal information on subjects becomes unrecognizable and the attributes of the subjects are recognizable. More specifically, the image processing system 10 generates a converted image from an original image such that computers cannot recognize personal information on subjects but can recognize the attributes of the subjects. Each subjects may be a person, or may be an object. For example, each subject may include at least one which is selected from a group composed of people, the faces of people, the license plates of vehicles, and buildings.

Personal information means information that allows each individual to be identified by distinguishing that individual from others. Personal information can be related to privacy. Personal information are not limited to some types. For example, as examples of personal information, the faces of people, the names of people, addresses, phone numbers, mail addresses, license plates (including the numbers on the license plates), property, nameplates, the exteriors and interiors of buildings, and so on can be taken. However, personal information is not limited thereto.

Attributes mean arbitrary general information representing the sorts or characteristics of subjects, or situations. The types of attributes are not limited. For example, if a subject is a person or the face of a person, the attribute can include at least one of the sex, the age group, the race, the direction of sight, the height, and the traveling direction. If a subject is a license plate, the attribute can include at least one of the region (local or non-local) indicated by the license plate, the color of the license plate, and the vehicle type indicated by the license plate. If a subject is a building, the attribute can include at least one of the age and type of the building, and whether it has a parking space.

As an example, the image processing system 10 processes the face of a person included in an original image, thereby generating a converted image in which the face is blurred. For example, the image processing system 10 generates the converted image such that people or computers cannot recognize the face which is a subject in the original image. Computers cannot recognize who that person is, even though processing the converted image. However, computers can recognize the attribute of that person by processing the converted image, and can recognize, for example, whether that person is a man or a woman, and which direction that person is facing. The image processing system 10 acquires a converted image by converting an original image such that personal information becomes unrecognizable. Therefore, it can be referred to as being a privacy protection device.

[Configuration of System]

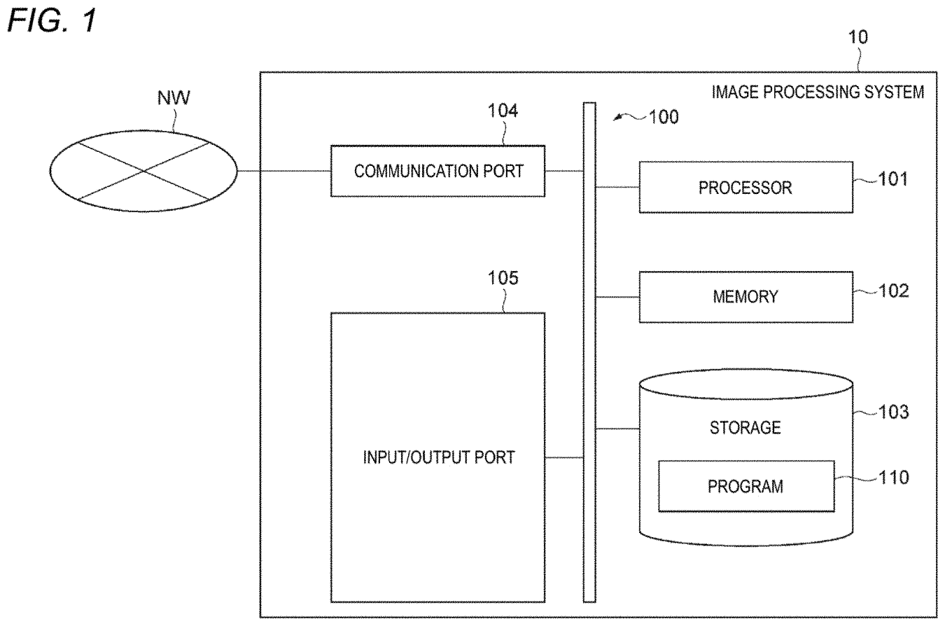

FIG. 1 illustrates an example of the hardware configuration of the image processing system 10. For example, the image processing system 10 includes a control circuit 10. As an example, the control circuit 10 includes one or more processors 101, a memory 102, a storage 103, a communication port 104, and an input/output port 105. The processor 101 executes an operating system and an application program. The storage 103 is configured with a non-transitory storage medium such as a non-volatile semiconductor memory or a medium which can be taken out (such as a magnetic disk or an optical disk), and stores the operating system and application programs. The memory 102 temporarily stores programs loaded from the storage 103, and the arithmetic results of the processor 101. As an example, the processor 101 functions as individual functional modules to be described below, by executing a program in cooperation with the memory 102. The communication port 104 performs data communication with other devices via a communication network NW, in response to commands from the processor 101. The input/output port 105 performs input and output of electric signals between the computer system and input/output devices (user interfaces) such as a keyboard, a mouse, and a monitor, in response to commands from the processor 101.

The storage 103 stores a program 110 for making a computer function as the image processing system 10. The processor 101 executes the program 110, whereby the individual functional modules of the image processing system 10 are implemented. The program 110 may be fixedly recorded in a non-transitory recording medium, such as a CD-ROM, a DVD-ROM, or a semiconductor memory, and be provided. Alternatively, the program 110 may be provided, as a data signal superimposed on a carrier, via the communication network.

The image processing system 10 can be configured with one or more computers. In the case where a plurality of computers is used, the computers are connected to one another via the communication network, such that physically, one image processing system 10 is configured.

Computers to function as the image processing system 10 are not limited. For example, the image processing system 10 may be configured with large-sized computers such as servers for business, or may be configured with small-sized computers such as portable terminals (such as smart phones, tablet terminals, and wearable terminals).

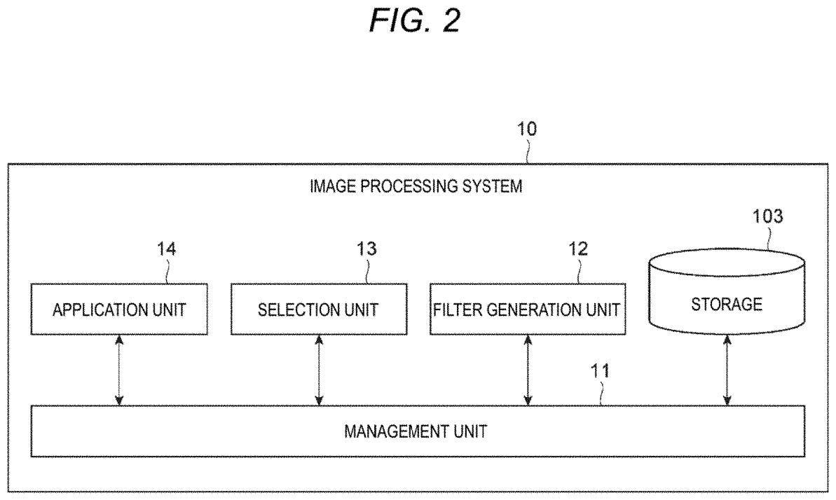

FIG. 2 is a view illustrating an example of the functional configuration of the image processing system 10. The image processing system 10 includes a management unit 11, a filter generation unit 12, a selection unit 13, and an application unit 14, as functional modules. The management unit 11 is a functional element which generally manages the process of generating converted images from original images. The filter generation unit 12 is a functional module which generates attribute filters. The selection unit 13 is a functional module which selects an attribute filter to be applied to an original image. The application unit 14 is a functional module which applies a selected attribute filter to an original image, thereby acquiring a converted image. Filters mean the functions of processing images, and attribute filters mean filters corresponding to the attributes of subjects. Attribute filters blur images such that personal information on subjects becomes unrecognizable and the attributes of the subjects are recognizable. The method of implementing attribute filters is not limited. For example, an attribute filter may be implemented by a program code, a setting file, or the combination of them.

[Procedure of Processing which is Performed in System]

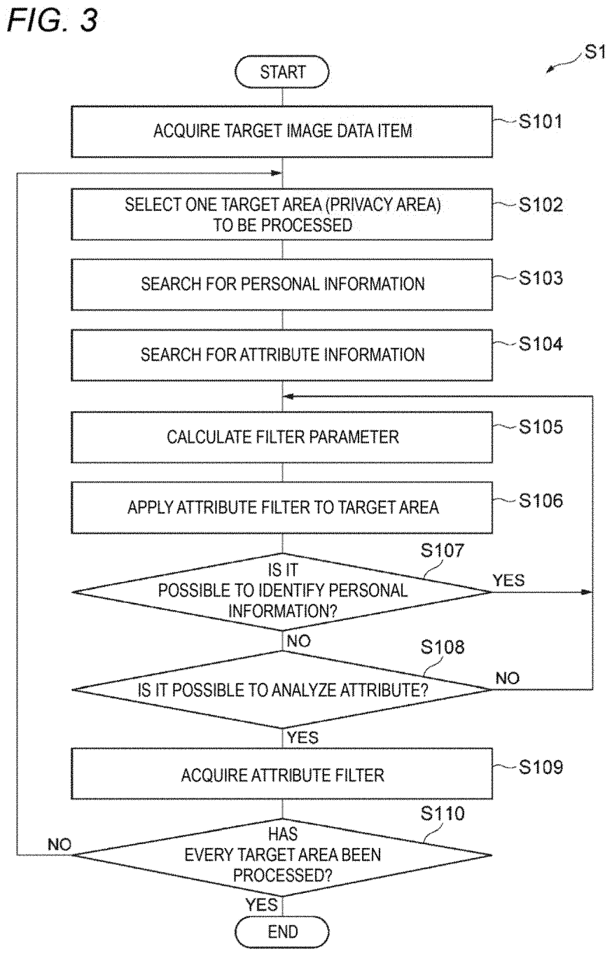

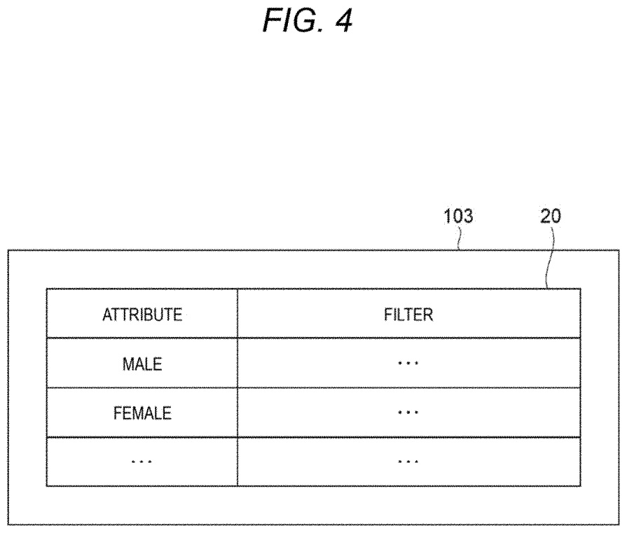

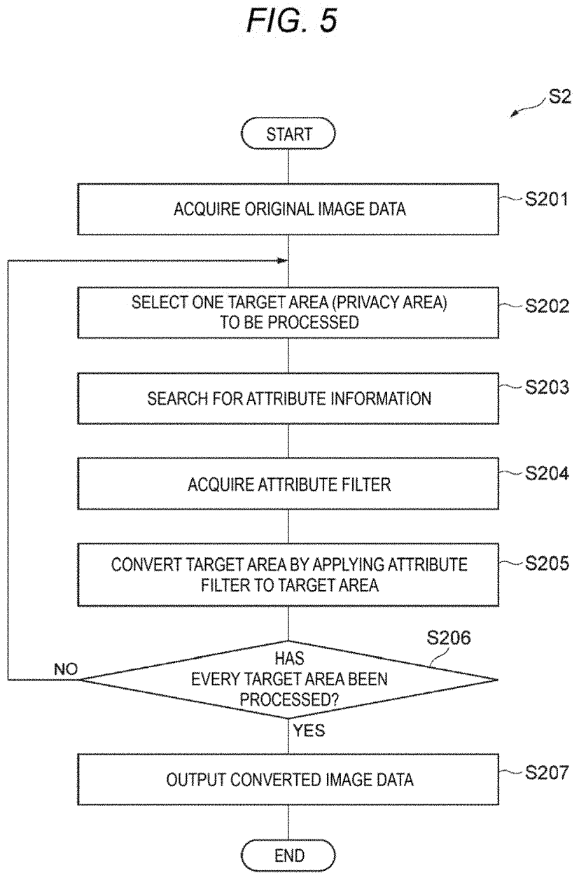

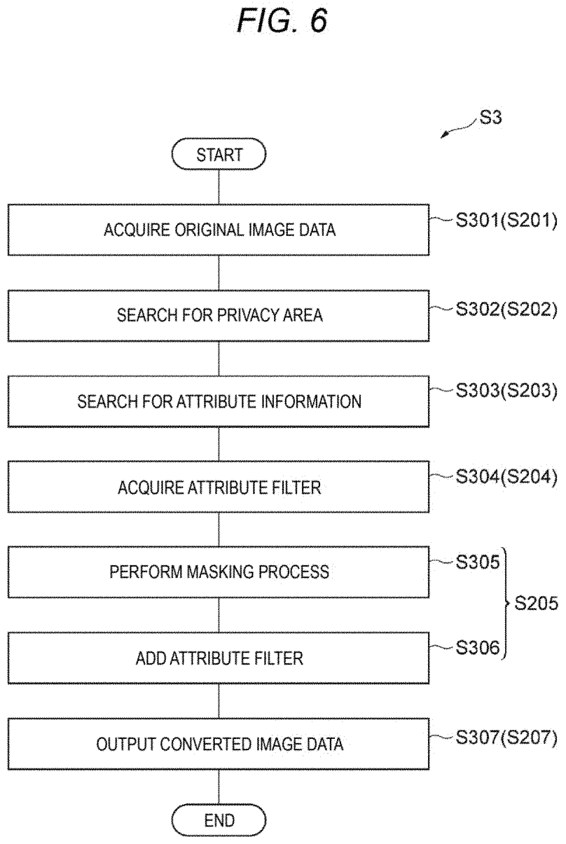

With reference to FIG. 3 to FIG. 6, the operation of the image processing system 10 will be described, and an image processing method according to the present embodiment will be described. FIG. 3 is a flow chart illustrating a processing flow S1 as an example of attribute filter generation. FIG. 4 is a view illustrating an example of attribute filters. FIG. 5 is a flow chart illustrating a processing flow S2 as an example of a process of acquiring a converted image by applying an attribute filter to an original image. FIG. 6 is a flow chart illustrating a processing flow S3 as a more concrete example of the processing flow S2.

The processing flow S1 will be described. In STEP S101, the management unit 11 acquires target image data. Target image data means data representing a target image which is used to generate attribute filters. The method of acquiring target image data is not limited. For example, the management unit 11 may access to a given database or memory, and read out target image data from that storage device. Alternatively, the management unit 11 may receive target image data from another computer. Alternatively, the management unit 11 may receive target image data inputted by the user.

In STEP S102, the management unit 11 selects one target area from the target image. Target areas mean areas to which attribute filters are applied. Since target areas mean areas from which it is possible to identify privacy, they can be referred to as being privacy areas. Target areas may be parts of target images. In this case, the management unit 11 may extract one or more target areas from a target image. Alternatively, a target area may be the whole of a target image. The method of extracting target areas is not limited. For example, the management unit 11 may automatically extract areas containing personal information, for example, specific areas such as faces, license plates, and nameplate, as target areas, using machine learning for object detection. The management unit 11 can use learnt models having parameters already adjusted, in the machine learning. As an example of the machine learning for object detection, a single shot multibox detector (SSD) can be taken; however, the machine learning is not limited thereto. Alternatively, the management unit 11 may recognize one or more areas selected by the user, as target areas. The management unit 11 selects one of the one or more target areas, as an object to be processed.

In STEP S103, the management unit 11 searches the selected target area for the personal information. This searching method also is not limited. For example, the management unit 11 may search for the personal information, using machine learning for object detection (for example, an SSD), or may search for the personal information by referring to arbitrary information associated with the target image. Instead of searching for the personal information, the management unit 11 may acquire personal information inputted by the user. In the case of succeeding in identifying the personal information when extracting the target area in STEP S102, the management unit 11 may acquire that personal information as it is, without performing the process of STEP S103.

In STEP S104, the management unit 11 searches the selected target area for the attribute information. Attribute information mean information representing the attributes of the subjects. The attribute information searching method also is not limited. For example, the management unit 11 may search for the attribute information, using machine learning for acquiring attributes. The management unit 11 can use learnt models having parameters already adjusted, in the machine learning. As an example of the machine learning for acquiring attributes, the visual geometry group (VGG) can be taken; however, it is not limited thereto. The management unit 11 may recognize the attribute information, using one or more learnt model. Instead of searching for the attribute information, the management unit 11 may acquire attribute information inputted by the user. The management unit may search for the attribute information by referring to arbitrary information associated with the target image.

Subsequently, the filter generation unit 12 performs a process for acquiring an attribute filter. In the processing flow S1, this process is explained with STEPS S105 to S109.

In STEP S105, the filter generation unit 12 calculates a filter parameter which is a parameter for configuring an attribute filter, and generates an attribute filter using the calculated filter parameter.

In STEP S106, the filter generation unit 12 applies the generated attribute filter to the target area. When the attribute filter is applied to the target area, the target area is converted such that the subject in the target area gets blurred out (i.e. such that the personal information of the subject becomes unrecognizable). As long as the generated attribute filter has a function of making personal information on the subject unrecognizable and making the attribute of the subject recognizable, the corresponding attribute filter can be used to process the original image.

In STEPS S107 and S108, the filter generation unit 12 verifies whether the attribute filter has the above-mentioned function. In STEP S107, the filter generation unit 12 verifies whether it is possible to identify the personal information from the target area subjected to application of the attribute filter. In STEP S108, the filter generation unit 12 verifies whether it is possible to analyze the attribute of the subject from the target area. In the case where it is not possible to recognize the personal information (“NO” in STEP S107), and it is possible to recognize the attribute (“YES” in STEP S108), the processing proceeds to STEP S109. In STEP S109, the filter generation unit 12 acquires the generated attribute filter, ad stores the attribute filter in the storage 103. This process means that the filter generation unit 12 has determined the filter parameter. As a result, the attribute filter for processing the original image is saved. Meanwhile, in the case where it is possible to recognize the personal information (“YES” in STEP S107) or it is impossible to recognize the attribute (“NO” in STEP S108), the processing returns to STEP S105. In this case, the filter generation unit 12 calculates the filter parameter again, and re-performs the processes of STEPS S106 to S108 on the basis of the calculated filter parameter.

The filter generation unit 12 may perform the processes of STEPS S105 to S109, using machine learning. For example, the filter generation unit 12 may perform the process of STEP S107, using machine learning (for example, an SSD) for object detection, and may perform the process of STEP S108, using machine learning for acquiring attributes (for example, the VGG). The filter generation unit 12 can use learnt models in each of the above-mentioned types of machine learning. In STEP S108, the filter generation unit 12 analyzes the attribute, using a learnt model corresponding to the attribute identified in STEP S104. In other words, the filter generation unit 12 selects a learnt model on the basis of the attribute information searched for from the target area, and verifies whether it is possible to recognize the attribute information from the target area subjected to application of the attribute filter, using the selected learnt model. The filter generation unit 12 may use a plurality of learnt models. For example, in STEP S108, the filter generation unit 12 can verify whether it is possible to recognize the attribute information, using a plurality of learnt models.

As shown in STEP S110, the image processing system 10 performs the processes of STEPS S102 to S109 on every extracted target area.

The image processing system 10 can generate a plurality of attribute filters corresponding to a plurality of attributes and save them in the storage 103, by performing the processing flow S1 on a plurality of items of target image data. In the example illustrated in FIG. 4, the storage 103 stores an attribute filter corresponding to an attribute “MALE”, an attribute filter corresponding to an attribute “FEMALE”, and so on. In association with one attribute, a plurality of attribute filters may be saved.

The configurations of attribute filters are not limited. For example, attribute filters may be Max filters which can be obtained by Expression 1, or may be Min filters which can be obtained by Expression 2. In association with one attribute, a Max filter and a Min filter may be saved in the storage 103.

[Expression 1]

Minimize c|r|⁻¹+loss_{f}(x+r,l). (1)

[Expression 2]

Minimize c|r|+loss_{f}(x′+r,l) (2)

Here, the variable “r” in Expressions 1 and 2 represents a filter parameter, and can be expressed as a two-dimensional matrix corresponding to a target area. |r| represents the norm. In the Max filter, the reciprocal of the norm is obtained. The variable “c” represents the coefficient for setting the level of importance of the norm regarding the right term. The right term represents the loss function of the machine learning for acquiring attributes. As an example other than Expressions 1 and 2, filter parameters may be calculated using a generative adversarial network.

In the case of using the Max filter, the filter parameter “r” is added to a target area x, whereby a converted image is obtained. Expression 1 is for maximizing the filter parameter “r” able to classify the converted image into Class 1. For this reason, Expression 1 is defined to minimize the reciprocal of the norm.

In the case of using the Min filter, the filter parameter “r” is added to an image x′ obtained by blurring the target area x by a masking process, whereby a converted image is obtained. Expression 2 is for minimizing the filter parameter “r” able to classify the converted image into Class 1. Since the filter parameter “r” becomes a small value, the image x′ and the converted image do not look very different.

With reference to FIG. 5, a processing flow S2 for acquiring a converted image from an original image will be described. In STEP S201, the management unit 11 acquires original image data. The method of acquiring original image data is not limited. For example, the management unit 11 may access to a given database or memory, and read out original image data from that storage device. Alternatively, the management unit 11 may receive original image data from another computer. Alternatively, the management unit 11 may receive original image data inputted by the user.

In STEP S202, the management unit 11 selects one target area (a privacy area) from the original image. Target areas may be parts of original images. In this case, the management unit 11 may extract one or more target areas from an original image. Alternatively, a target area may be the whole of an original image. The method of extracting target areas is not limited. For example, the management unit 11 may automatically extract areas containing personal information, for example, specific areas such as faces, license plates, and nameplates, as target areas, using machine learning for object detection (for example, an SSD). The management unit 11 can use learnt models having parameters already adjusted, in the machine learning. Alternatively, the management unit 11 may recognize one or more areas selected by the user, as target areas. The management unit 11 selects one of the one or more target areas, as an object to be processed.

In STEP S203, the management unit 11 searches the selected target area for the attribute information. The attribute information searching method also is not limited. For example, the management unit may search for the attribute information, using machine learning for acquiring attributes (for example, VGG). The management unit 11 can use learnt models having parameters already adjusted, in the machine learning. Instead of searching for the attribute information, the management unit 11 may acquire attribute information inputted by the user.

In STEP S204, the selection unit 13 acquires an attribute filter. The method of acquiring attribute filters is not limited. As an example, the selection unit 13 may read out an attribute filter corresponding to the attribute information from the storage 103. In the case where a plurality of attribute filters associated with the attribute represented by the attribute information exists in the storage 103, the selection unit 13 may select an attribute filter selected by the user. Alternatively, the filter generation unit 12 may dynamically generate an attribute filter corresponding to the attribute information by performing the processes of STEPS S105 to S109 described above, and the selection unit 13 may acquire the generated attribute filter. Alternatively, the selection unit 13 may attempt to acquire an attribute filter corresponding to the attribute information from the storage 103, and instruct the filter generation unit 12 to generate an attribute filter, if it fails in acquiring. In response to that instruction, the filter generation unit 12 performs the processes of STEPS S105 to S109 described above, thereby dynamically generating an attribute filter corresponding to the attribute information. Then, the selection unit 13 acquires that attribute filter.

In STEP S205, the application unit 14 converts the target area by applying the acquired attribute filter to the target area. The process of applying the attribute filter to the target area is a process of changing the R, G, and B values of each of the pixels in the target area by the attribute filter. By this process, the target area is changed such that the personal information on the subject becomes unrecognizable and the attribute of the subject is recognizable. As an example, the application unit 14 blurs the subject in the target area by converting the target area.

As shown in STEP S206, the image processing system 10 performs the processes of STEPS S202 to S205 on every extracted target area. If every target area is processed, the processing proceeds to STEP S207. Proceeding to STEP S207 means that a converted image including one or more target areas converted by attribute filters has been generated.

In STEP S207, the management unit 11 outputs converted image data representing the converted image. The method of outputting converted image data is not limited. For example, the management unit 11 may store the converted image data in a given storage device such as the storage 103 or a database. Alternatively, the management unit 11 may display the converted image data on a monitor, or may transmit the converted image data to another computer.

With reference to FIG. 6, a processing flow S3 which is a concrete example in which a converted image is acquired from an original image will be described. A description of processes identical or equal to those in the processing flow S2 will not be made.

In STEP S301 identical to STEP S201, the management unit 11 acquires original image data. In STEP S302, the management unit 11 searches the original image for a privacy area (a target area). In this example, it is assumed that the management unit 11 extracts one target area and selects that area. STEP S302 is identical to STEP S202. In STEP S303 identical to STEP S203, the management unit 11 searches for the attribute information of the target area. In STEP S304 identical to STEP S204, the selection unit 13 acquires an attribute filter. In STEP S305, the management unit 11 performs a masking process using another filter such as a Gaussian filter, on the target area, thereby blurring the target area. By this process, the target area is converted such that at least the personal information on the subject becomes unrecognizable. In STEP S306, the application unit 14 coverts the blurred target area by adding the attribute filter to the blurred target area, thereby acquiring a converted image. This adding process is an example of attribute filter application. Specifically, the application unit 14 adds the Min filter to the target area. By this process, the target area is changed such that the personal information on the subject becomes unrecognizable but the attribute of the subject is recognizable. The combination of STEPS S305 and S306 is an example of STEP S205. In STEP S307 identical to STEP S207, the management unit 11 outputs converted image data representing the converted image.

[Effects]

As described above, the computer system according to the aspect of the present disclosure includes the processor. The processor recognizes the attribute of a subject in a target area of an original image which is represented by original image data, and converts the target area by applying a filter corresponding to the attribute to the target area such that personal information on the subject becomes unrecognizable and the attribute of the subject is recognizable, and outputs converted image data representing a converted image including the converted target area.

The program according to the aspect of the present disclosure makes a computer perform a step of recognizing the attribute of a subject in a target area of an original image which is represented by original image data, a step of converting the target area by applying a filter corresponding to the attribute to the target area such that personal information on the subject becomes unrecognizable and the attribute of the subject is recognizable, and a step of outputting converted image data representing a converted image including the converted target area.

A computer-readable non-transitory recording medium according to the aspect of the present disclosure stores the program for making a computer perform a step of recognizing the attribute of a subject in a target area of an original image which is represented by original image data, a step of converting the target area by applying a filter corresponding to the attribute to the target area such that personal information on the subject becomes unrecognizable and the attribute of the subject is recognizable, and a step of outputting converted image data representing a converted image including the converted target area.

In this aspect, a filter corresponding to an attribute is applied to a target area of an original image such that personal information on the subject becomes unrecognizable and the attribute of the subject is recognizable. In the case of applying a Gaussian filter according to the related art to an original image, not only the personal information but also the attribute is eliminated. Meanwhile, according to the above-described technology disclosed in Patent Literature 1, there is a possibility that personal information might be restored. Therefore, it is not adequate to protect privacy. As another technology according to the related art, there is masking using artificial personal information such as artificial faces. However, in this case, people cannot determine whether masking has been performed, and cannot determine even whether personal information is contained in an image. According to the above-described aspect of the present disclosure, it is possible to solve those technical problems of the technologies according to the related art, and appropriately process original images.

In a computer system according to another aspect, the processor may acquire a filter by referring to a storage unit storing the correspondence relation between attributes and filters, and convert a target area by applying the acquired filter to the target area. Since the prepared filters are used, it is possible to immediately convert target areas.

In a computer system according to another aspect, the processor may determine a filter parameter for configuring a filter, and generate a filter using the determined filter parameter, and convert a target area by applying the generated filter to the target area, such that the personal information becomes unrecognizable and the attribute is recognizable. By dynamically generating filters as described above, it is possible to appropriately convert target areas, without preparing filters in advance.

In a computer system according to another aspect, determining a filter parameter may include calculating a filter parameter, generating a filter using the calculated filter parameter, converting a target area by applying the generated filter to the target area, verifying whether it is possible to recognize the personal information from the converted target area, verifying whether it is possible to recognize the attribute from the converted target area, and determining the filter parameter if it is impossible to recognize the personal information from the converted target area and it is possible to recognize the attribute. By this processing procedure, it is possible to dynamically generate filters able to appropriately process original images.

In a computer system according to another aspect, the processor may convert a target area by performing the followings: acquiring a filter by referring to a storage unit storing the correspondence relation between attributes and filters; and converting a target area by applying the acquired filter to the target area; if failing in acquiring a filter from the storage unit, (A) determining a filter parameter for configuring a filter; (B) generating a filter using the determined filter parameter; and (C) applying the generated filter to the target area, such that the personal information becomes unrecognizable and the attribute is recognizable. In the case where there is no filter that should be used, a filter to be used is dynamically generated. Therefore, it is possible to appropriately covert the target area.

In a computer system according to another aspect, the processor may select areas containing personal information, as target areas, from original images. By this process, it is possible to surely protect personal information.

In a computer system according to another aspect, the processor may blur subjects by converting target areas. By this process, it is possible to prevent personal information from being visually recognized by people.

In a computer system according to another aspect, the processor may blur the subjects by applying filters, different from filters corresponding to attributes, to the target areas, and apply the filters corresponding to the attributes to the target areas containing the blurred subjects. By this process, it is possible to prevent personal information from being visually recognized by people.

In the computer system according to another aspect, the different filters may be Gaussian filters.

In a computer system according to another aspect, each subject may include at least one selected from a group composed of people, the faces of people, license plates, and buildings. In this case, it is possible to surely protect the personal information.

In an example, road images are collected using survey vehicles. In order to provide the road images to other companies, it is required to consider privacy protection. For example, on Google Street View, the faces of individuals, the license plates of vehicles, and nameplates on houses present in the images are blurred in order to protect the personal information.

Nowadays, computer image-processing technologies are widely used to analyze images and extract general object attribute information from the images. For example, it is possible to count the number of people in each image by a human face detection technology. Age or sex estimation technologies extract general object attributes from face photographs.

However, in the case where a masking method according to the related art using a Gaussian blur filter or the like is performed on images in order to protect personal information, the filter eliminates, degrades, or modifies all of the image features in the target areas. This influences extraction of general object attributes. For example, some human face detectors cannot count the numbers of people present in images containing faces masked by Gaussian blur filters.

In order to solve this problem, in Japanese Patent Application Laid-Open No. 2011-129096, a technology for maintaining any one of edge information, shape information, and color distribution information while moving pixels in target areas in order to protect personal information is disclosed. However, according to this method, there is a possibility that original personal information might be restored.

Another solution is to replace human faces present in photographs with other human faces having the same general object attributes. However, this method has two problems. First, people who see the images cannot determine whether the images have been processed for protecting privacy. Also, the copyright on the added face images is not clear.

In order to solve the above-mentioned problems, a new masking method capable of analyzing attributes masked by a computer vision method while making it difficult to identify personal information is proposed.

This method is a privacy protection method. This method is composed mainly of two components. The first component is an attribute filter application unit which masks objects by pixel image patterns representing general object attributes which can be analyzed by image analysis programs. The second component is an attribute filter selection unit which selects an attribute filter generated by each image analysis program.

Examples of configurations and methods which the technologies according to the related art do not include are as follow. One is to have the attribute filter application unit for adding attribute filters which can be analyzed by image analysis programs. Another is that attribute filters which are generated by the attribute filter application unit mask personal information while providing attributes which can be analyzed by image analysis programs.

This method protects privacy of objects which are contained in images and are analysis objects while maintaining the attributes of the objects.

The attribute filter application unit for generating filters is optimized by back propagation in order to analyze general object attribute information while protecting personal information.

It becomes possible to provide road images processed for privacy protection to other companies to analyze the images for marketing.

[Modifications]

The above description has been made in detail on the basis of the embodiment of the present disclosure. However, the present disclosure is not limited to the above-described embodiment. The present disclosure can be modified in various forms without departing from the gist of the present disclosure.

In the above-described embodiment, the image processing system 10 converts target images, thereby blurring the subjects in the target areas. However, the image processing system may perform processing other than blurring, such as fogging or mosaicing on subjects.

The image processing system 10 may not include the filter generation unit 12. For example, in the case where a sufficient number of types of attribute filters are prepared in advance, the filter generation unit 12 can be omitted. In the case where the image processing system 10 always dynamically generates attribute filters, it is not necessarily needed to store attribute filters in the storage 103 in advance.

In the present disclosure, the expression “The processor performs a first process, and performs a second process, and . . . , and performs an N-th process.” and expressions corresponding to that expression represent a concept including the case where the subject (i.e. the processor) which performs the n-number of processes of the first process to the n-th process is changed in the course. In other words, this expressions represent a concept including both of the case where all of the n-number of processes are performed by the same processor and the case where switching between processors is performed according to an arbitrary policy in the cause of the n-number of processes.

When comparing two numerical values in the computer system in order to determine the relationship in magnitude, any one of the two criteria “equal to or larger than” and “larger than” may be used, and any one of the two criteria “equal to or smaller than” and “smaller than” may be used. This criterion selection does not change the technical significance of the process of comparing two numerical values in order to determine the relationship in magnitude.

The processing procedures of methods which can be performed by the processor are not limited to the examples shown in the above-described embodiment. For example, some of the above-described steps (processes) may be omitted, and the individual steps may be performed in a different order. Also, two arbitrary steps of the above-described steps may be combined, or some of the steps may be modified or eliminated. Alternatively, in addition to the above-described individual steps, other steps may be performed.

The modes disclosed in the whole or a part of the above-described embodiment achieve any one object of control on image processing, improvement in the speed of processing, improvement in the accuracy of processing, improvement in usability, improvement in functions using data or provision of appropriate functions using data, improvement in other functions or provision of other appropriate functions, reduction in the capability required for data and programs, provision of data, programs, recording media, devices, and/or systems adequate for reduction in the sizes of devices and/or systems, and optimization of creation and manufacturing of data, programs, recording media, devices, and/or systems, such as reduction in the creation and manufacturing costs of data, programs, devices, and/or systems, facilitation of the creation and manufacturing, and reduction in the creation and manufacturing times.

The content of the present disclosure can be defined as follows.

(1) A privacy protection device is composed of an attribute filter application unit and an attribute filter selection unit. The attribute filter application unit adds attributes which can be analyzed by image analysis programs. The attribute filter selection unit selects an attribute filter generated for each analysis program.

(2) The attribute filter application unit stores filters for masking personal information while maintaining the attributes of objects in order for analysis.

(3) Each filter to be provided by the attribute filter application unit is generated by an attribute filter generation unit on the occasion of filter addition or before filter addition.

(4) The attribute filter generation unit is composed of a process of identifying not only personal information but also attributes, and an attribute filter generating process.

(5) The attribute filter generation unit identifies privacy information and general attributes of objects. Subsequently, the attribute filter generation unit masks the primary information and maintains general attribute information which image analyzes programs can recognize.

(6) In the device of (1), in the case of adding an attribute filter, primary information may be masked with a Gaussian blur filter or the like.

(7) In the device of (1), the attribute filter application unit adds a plurality of attributes.

(8) In the device of (1), the attribute filter selection unit is composed of a privacy protection object detecting process, an attribute information detecting process, and an attribute filter acquiring process.

(9) The attribute filter selection unit can have a filter size determined on the basis of the image size and the like during analysis, as a parameter.

(10) In the device of (8), the attribute filter acquiring process acquires a filter generated and stored by the attribute filter generation unit, in response to a request from the attribute information detecting process.

(11) In the device of (8), in the case where the attribute filter acquiring process fails in detecting appropriate attribute information, the privacy protection device requests the attribute filter generation unit to generate attribute information.
10 Image Processing System
11 Management Unit
12 Filter Generation Unit
13 Selection Unit
14 Application Unit
110 Program

What is claimed is:

1. A computer system, comprising:
a processor configured to:
recognize an attribute of a subject in a target area of an original image which is represented by original image data;
convert the target area by applying a filter corresponding to the attribute to the target area such that personal information on the subject becomes unrecognizable and the attribute of the subject is recognizable; and
output converted image data representing a converted image including the converted target area.

2. The computer system according to claim 1, wherein
the processor is configured to:
determine a filter parameter for configuring the filter in order to make personal information unrecognizable and make the attribute recognizable;
generate the filter using the determined filter parameter; and
convert the target area by applying the generated filter to the target area.

3. The computer system according to claim 2, wherein
in the determining of the filter parameter, the processor is configured to:
calculate the filter parameter;
generate the filter using the calculated filter parameter;
convert the target area by applying the generated filter to the target area;
verify whether it is possible to recognize the personal information from the converted target area;
verify whether it is possible to recognize the attribute from the converted target area; and
determine the filter parameter, in a case where it is not possible to recognize the personal information from the converted target area and it is possible to recognize the attribute from the converted target area.

4. The computer system according to claim 1, wherein
the processor is configured to:
acquire the filter by referring to a storage unit storing a correspondence relation between the attribute and the filter;
convert the target area by applying the acquired filter to the target area; and
in a case where it is impossible to acquire the filter from the storage unit,
determine a filter parameter for configuring the filter, in order to make the personal information unrecognizable and make the attribute recognizable,
generate the filter using the determined filter parameter, and
convert the target area by applying the generated filter to the target area.

5. The computer system according to claim 4, wherein
in the determining of the filter parameter, the processor is configured to:
calculate the filter parameter;
generate the filter using the calculated filter parameter;
convert the target area by applying the generated filter to the target area;
verify whether it is possible to recognize the personal information from the converted target area;
verify whether it is possible to recognize the attribute from the converted target area; and
determine the filter parameter, in a case where it is not possible to recognize the personal information from the converted target area and it is possible to recognize the attribute from the converted target area.

6. A non-transitory computer-readable storage medium that stores a program for making a computer to execute a process, the process comprising:
recognizing an attribute of a subject in a target area of an original image which is represented by original image data;
converting the target area by applying a filter corresponding to the attribute to the target area such that personal information on the subject becomes unrecognizable and the attribute of the subject is recognizable; and
outputting converted image data representing a converted image including the converted target area.

7. A computer system, comprising:
a processor configured to:
recognize an attribute of a subject in a target area of an original image which is represented by original image data;
convert the target area by applying a first filter such that personal information on the subject becomes unrecognizable;
convert the target area by applying a second filter corresponding to the attribute to the target area such that the attribute of the subject is recognizable; and
output converted image data representing a converted image including the converted target area.

8. A computer system according to claim 7, wherein
the first filter is a Gaussian filter.

9. A computer system according to claim 7, wherein
the subject includes faces of people.
